(19) United States
(12) Patent Application Publication
(10) Pub. No.: US 2007/0284262 A1
(43) Pub. Date: Dec. 13, 2007

(54) Method of Detecting Shorts and Bad Contacts in an Electrolytic Cell

(76) Inventors: Eugene Yanjun You, Salt Lake City, UT (US); Daniel Kang Kim, Salt Lake City, UT (US)

Correspondence Address: WHYTE HIRSCHBOECK DUDEK S C, 555 EAST WELLS STREET, SUITE 1900, MILWAUKEE, WI, 53202, US

(21) Appl. No.: 11/756,222

(22) Filed: May 31, 2007

Related U.S. Application Data
(60) Provisional application No. 60/804,306, filed on Jun. 9, 2006.

(51) Int. Cl. G01N 27/26

(52) U.S. Cl. 205/775

(57) ABSTRACT

A method of detecting shorts and bad contacts in an electrolytic cell, the cell comprising a housing, electrolyte and at least one anode/cathode pair, the housing comprising an electrolyte in-flow side and an electrolyte out-flow side and electrical transmission means, the anode/cathode pair, electrolyte and electrical transmission means in electrical communication with one another, the method comprising:
A. Passing an electric current of pre-determined amperage through the cell;
B. Measuring the voltage drop across the cell at the electrolyte in-flow side of the housing and at the electrolyte out-flow side of the housing,
C. Comparing the electrolyte in-flow side voltage against the electrolyte out-flow side voltage, and
D. Comparing the electrolyte in-flow and out-flow side voltages against a calculated or estimated target voltage.

### CROSS-REFERENCE TO RELATED APPLICATION

This application claims priority under 35 U.S.C. §119(e) to Provisional Patent Application Ser. No. 60/804,306, filed on Jun. 9, 2006, the entire disclosure of which is hereby incorporated by reference.

### FIELD OF THE INVENTION

In one aspect, the invention relates to electrolytic cells while in another aspect, the invention relates to the detection of shorts and bad contacts in electrolytic cells. In still another aspect, the invention relates to an electrolytic cell monitoring system for detection of shorts and bad contacts in electrolytic cells used for the refinement of copper. In yet another aspect, the invention relates to detection of shorts and bad contacts in electrolytic cells used in electrowinning and other applications.

### BACKGROUND OF THE INVENTION

In an electrolytic copper refinery, the anodes are lowered into an acidic solution that contains approximately 120-250 grams per liter (gpl) of free sulfuric acid and approximately 30-50 gpl of dissolved copper. The anodes are also electrically connected to a positive direct current supply. To electrolyze the anodes in this aqueous electrolyte, they are separated by insoluble, interleaved stainless steel blanks called starter sheets or cathodes, which are negatively charged. Electricity is then sent between the anodes and cathodes for a pre-determined length of time, causing copper ions to migrate from the anodes to the cathodes to form plates at the cathodes, which contain less than 20 parts per million impurities (i.e., sulfur plus non-copper metals, but not including oxygen). Voltages of approximately 0.1-0.5 volts are generally sufficient to dissolve the anodes and deposit the copper on the cathodes, with corresponding current densities of approximately 160-380 amperes per square meter (amps/m²). With each anode producing two cathode plates at which the refined copper is deposited, the cathode plates are then washed and ready for ultimate end use.

In a typical copper refinery producing 300,000 tons of copper cathodes per year, there can be as many as 1,440 electrolytic cells, each with 46 anodes and 45 cathode blanks, for a total of 131,000 pieces suspended into the cells. In such a traditional copper refinery, each cathode and each anode is electrically connected to the refinery current supply system through two or more contact points on the supporting ears of the anodes and the hanger bars of the cathodes. This means there can be a total of over 260,000 electrical connections (i.e., two per anode and two per cathode multiplied by the number of cathodes and anodes).

Critical to the efficient operation of the refining process is the absence of bad contacts and short circuits between the anodes and cathodes. Short circuits can occur if the anodes and cathodes are mis-aligned or if copper deposits on the cathode grow in a non-uniform manner and contact the anode. When short circuits do occur, the desired copper plating process is disrupted. Bad contacts, on the other hand, can occur if there is poor contact between the current supply and the ears of the anodes or the hanger bars of the cathodes. Bad contacts can decrease electrical use efficiency.

The efficiency of copper refinement can be increased by increasing the efficiency of cell monitoring, and more specifically, increasing the efficiency of monitoring cell voltage. Failure to adequately monitor cell voltage can reduce metal recovery, increase scrap rate, and lead to inefficient energy utilization. Nevertheless, most electrolytic metal recovery and refining facilities do not effectively monitor this cell parameter primarily due to the high capital and operating costs associated with such cell monitoring. For example, these costs are significantly high when each individual electrolytic cell in a tank house is hardwired for monitoring this parameter. Doing so generally requires a significant amount of hardwiring in an environment that is inherently hostile, inherently corrosive, and inherently subject to large magnetic fields. In particular, while the voltage differential across any cell is on the order of 0.1 to 0.5 volts, the voltage differential across a rectifier can be over one hundred volts. It is inherently unsafe to simply connect wires to the individual cells and route these to voltage monitoring equipment because the voltage potential can be potentially fatal. Because presently existing cell monitoring equipment and technologies are expensive and require extensive hard wiring, both shortcomings have significantly deterred widespread market penetration of effective electrolytic cell monitoring.

As a result, bad contacts and short circuits commonly occur during the electrolytic refining (and electrowinning) of copper. They occur for many reasons, including i) poor anode and cathode physical qualities, ii) poor contact between the current supply and the anodes or cathodes, iii) misalignment of anodes and cathodes, and iv) localized variations in electrolyte temperature, additive levels, or chemistry. Thus, efficient electrolytic cell monitoring is important during the electrolytic refining and/or electrowinning of copper, as it can enable system operators to detect bad contacts between the bus and anode and/or cathode, and short circuits between anodes and cathodes, which, if not cleared, reduce current efficiencies and result in down-stream processing problems, such as poor cathode development. As known, copper impurity, copper content, and copper appearance are also ultimately adversely affected by bad contacts and short circuits.

Conventional monitoring focuses on only identifying short circuits between the anodes and cathodes. This is commonly accomplished by manually using a hand-held Gauss meter to detect abnormal magnetic fields flowing through the cathode. Such a procedure generally requires physically walking over the anodes and cathodes in each cell while closely observing the hand-held Gauss meter to detect a large deflection in a meter needle. Oftentimes, the Gauss meter is affixed to a distal end of a long stick or pole by which it can then be held close to the cathode hanger bar. Regardless, the task is both ergonomically difficult and accident-prone. Moreover, walking on the cells frequently misaligns the anode and cathodes, can lead to possible contamination, and often leads to further problems as well.

While detecting bad contacts and short circuits deals with their effects rather than their causes, it is a widely recognized technique for improving electrode quality. Accordingly, after a short circuit is detected, it is generally cleared by probing between the cathode and anode with a stainless steel rod to locate the fault and then physically separating (i.e., breaking off) an errant copper nodule growing at the epicenter of the short circuit. This often requires physically lifting the cathode out of the cell. Unfortunately, however, many bad contacts and short circuits are not often detected until after significant damage has already occurred.

Consequently, there is a need for less expensive, less intrusive, lower maintenance, and higher efficiency electrolytic cell monitoring systems and methods. Such systems and methods would increase energy utilization and efficiency during the electrolytic refinement and electrowinning of copper and in other applications as well, e.g., electrolysis of water, sodium hydroxide and other compounds, electrodeposition, electrocoating, electroforming, etc. Thus, a need exists for a cost effective, minimally intrusive, minimal maintenance, and increasingly efficient electrolytic cell monitoring systems and methods for measuring anode and cathode voltages during the electrolytic refinement and/or electrowinning of copper.

### SUMMARY OF THE INVENTION

In one embodiment, the invention is a method of detecting shorts and bad contacts in an electrolytic cell, the cell comprising a housing, electrolyte and at least one anode/cathode pair, the housing comprising an electrolyte in-flow side and an electrolyte out-flow side and electrical transmission means, the anode/cathode pair, electrolyte and electrical transmission means in electrical communication with one another, the method comprising:
A. Passing an electric current of pre-determined amperage through the cell;
B. Measuring the voltage drop across the cell at the electrolyte in-flow side of the housing and at the electrolyte out-flow side of the housing,
C. Comparing the electrolyte in-flow side voltage against the electrolyte out-flow side voltage, and
D. Comparing the electrolyte in-flow and out-flow side voltages against a calculated or estimated target voltage.
   The target voltage is a function of the total current passing through the cell, the effective area of the anode and cathode, the average distance between the anode and cathode, the composition and the temperature of the electrolyte. The typical target voltage for a copper refining cell is between about 0.1 and 1, preferably between about 0.2 and 0.7. For other types of electrolytic cells, e.g., a cell used for the electrowinning of copper, the target voltage can be much higher, e.g., between about 1 and 4 volts.

In another embodiment, the electrolytic cell is an electrolytic cell for refining copper. The housing comprises a concrete, rectangular tank having an open top side, the electrolyte comprises sulfuric acid, the electrical transmission means comprises a copper bus, and the anode/cathode pair comprises anode copper and cathode copper.

### BRIEF DESCRIPTION OF THE DRAWINGS

FIG. 1 is a representation of an electrolytic cell for the refinement of anode copper to cathode copper.

FIG. 2 is a schematic diagram of a monitoring system comprising an ECM in communication with a coordinator in communication with a computer.

FIG. 3 is a schematic representation of a simplified model of multiple electrolytic cells connected serially and powered by a current source.

FIG. 4 is the schematic representation of FIG. 3 in which one of the cells has a short.

FIG. 5 is a set of data measured across test electrolytic cells.

### DESCRIPTION OF THE PREFERRED EMBODIMENT

“Short circuit”, “short” and similar terms mean an accidental or unintended low-resistance connection between two nodes of an electrical circuit that are at different voltages. This can result in an excessive electric current limited only by the internal impedance of the current source and potentially causes circuit damage and/or overheating.

“Bad contact” and similar terms mean an accidental or unintended high-resistance connection between the buses of the electrolytic cell and the hanger bars of the cathode and ears of the anode,

“Vertical current” and similar terms mean the current that travels along or down a bus as opposed to the current that travels across buses through anodes and cathodes as intended.

“Anode copper” means copper cast in the form of an eared anode ready for electrorefining. The copper in a typical copper anode has been fire-refined, e.g., in an anode furnace, to remove sulfur and oxygen to levels of about 0.001 and 0.15 weight percent or less, respectively. Typical copper anodes weigh about 300 pounds, and are cast on an anode casting wheel.

“Cathode starter sheet” and similar terms mean the sheet used as the cathode in an electrolytic refining cell at the beginning of a process to electrorefine anode copper. These starter sheets typically comprise stainless steel.

“Cathode copper” means copper that has been electrorefined. The copper of cathode copper is typically comprises greater than 99 weight percent copper.

“Electrolyte” means a substance that will provide ionic conductivity when dissolved in water or when in contact with it. In the context of copper electrorefining, the typical electrolyte is CuSO₄/H₂SO₄/H₂O.

“Effective area between an anode and cathode” and similar terms mean the surface of an anode or cathode which is both submerged in the electrolyte and is directly opposite the surface of its counterpart cathode or anode.

“Average distance between an anode and cathode” and similar terms mean the intended or target distance separating the anodes and cathodes in an electrolytic cell. In any given electrolytic cell, the distance between each anode and cathode in the cell is ideally the same.

Although the detection method of this invention is applicable to a wide variety of electrolytic cells, it is described here in the context of an electrolytic cell used in the electrorefining of copper as a representative example. The electrorefining of copper is broadly described by Biswas and Davenport in Extractive Metallurgy of Copper, 3^{rd} Ed., pp. 324-357 (Pergamon, 1994). Other electrolytic cells to which the invention is applicable include those used in the electrowinning of metals and the electrolysis of sodium chloride to make sodium hydroxide.

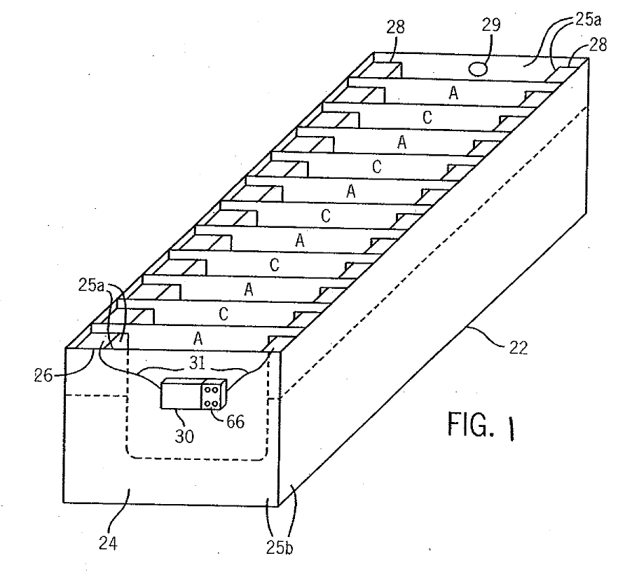

Referring now to FIG. 1, electrolytic cell 22 is shown, in which anode copper plates A (i.e., “anodes”) and cathode starter sheets C (i.e., “cathodes”) are alternately arranged close to one another and immersed in aqueous electrolyte 24 contained within internal walls 25a of electrolytic cell 22. During copper production, aqueous electrolyte 24 is normally filled relatively close to top surface 26 of electrolytic cell 22, although a lesser amount is shown in the figure for clarity. Electrolyte is continually circulated throughout the cell during the electrorefining process. Within electrolytic cell 22, anodes A and cathodes C are in ear and hanging bar contact, respectively, with current rails 28 running lengthwise on top surface 26 of electrolytic cell 22. The surfaces of the anodes and cathodes submerged within the electrolyte are aligned or congruent with one another as best as practical to ensure maximum efficiency of the electrorefining process. Current rails 28 carry electrical current to electrolytic cell 22 to assist in copper ion migration from anodes A to the cathodes C. Although electrolytic cell 22 is generally at an ultra-low voltage (i.e., 0.1-0.8 volts), 25,000 amperes of current is not uncommon about electrolytic cell 22. This cell voltage is typically powered by a bus voltage, which is the voltage impressed across anodes A and cathodes C for the ion migration.

A common copper-producing tank house contains as many as forty (40) sections, each of which contains thirty-six (36) electrolytic cells 22. Moreover, a typical electrolytic cell contains as many as forty-six (46) anode-cathode A-C pairs and can often yield as many as 1440 cells in a common tank house, or in excess of 66,240 anode-cathode A-C pairs. Since short and bad contact circuits can occur between any of anode-cathode A-C pairs at any time, constant electrolytic cell monitoring is greatly beneficial to increasing copper production and use of the energy supplied to the cells.

Accordingly, cell-powered microprocessor-based ECM 30 is electrically attached to electrolytic cell 22, with electrical connections 31 connecting ECM 30 to current rails 28 of electrolytic cell 22. Preferably, a suitable mechanical connection also connects ECM 30 to electrolytic cell 22. For example, in one preferred embodiment, ECM 30 is suspended from a wire form (not shown) depending from top surface 26 along suitable external wall 25b of electrolytic cell 22. In another preferred embodiment, electrolytic cell 22 is cast with an indentation suited to receive ECM 30. In yet another preferred embodiment, one or multiple ECMs 30 straddle adjacent cells 22 that are aligned in close physical proximity to one another. Moreover, if ECM 30 is in close physical contact with electrolytic cell 22, it is preferably encased in a suitable housing to protect it from the harsh environment to which it is exposed. In any event, techniques and methods of electro-mechanical attachment are known in the art and not specifically intended as integral components of the general inventive arrangements. Rather, suitable locations and attachment methods are chosen, preferably to maximize wireless (e.g., radio) link strengths and minimize interference with other copper production steps, such as clearing short circuits as operators walk along top surface 26 of electrolytic cell 22.

In addition, ECM 30 is also attached to, and in electrical communication with, a sensor (not shown) that monitors cell voltage. Accordingly, suitable voltage sensors (e.g., an analog to digital (A/D) converter) monitor cell voltage. In one embodiment, the cell voltage sensor comes with the microprocessor on the electrolytic cell monitor board. The microprocessor handles communication, booster control and all other functions of the monitor. The A/D terminal of the microprocessor is connected to the cell bus of the refining cell to take measurements of the cell voltage.

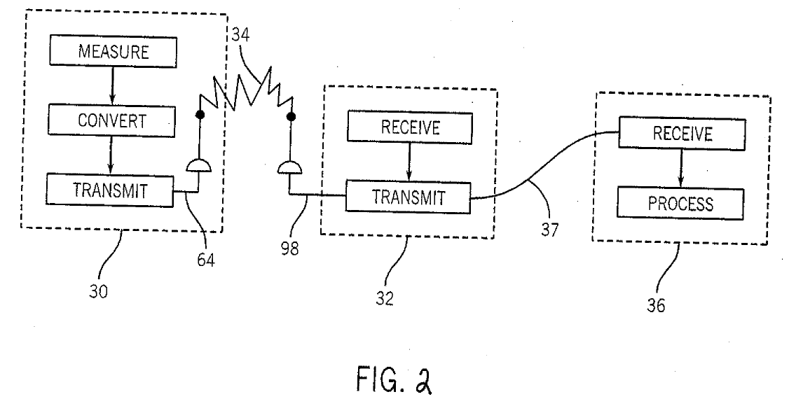

Referring now to FIG. 2, ECM 30 is preferably in electronic communication with one or more coordinators 32 over a hard-wired or, preferably, over a real-time, wireless communications network 34, and coordinators 32 are themselves in communication (either hard-wired or wireless) with computer 36. Preferably, communication between ECMs 30 and coordinators 32 is two-way, with each device comprising transmitting and receiving capabilities. ECMs 30 are also programmed, of course, to monitor, i.e., measure, the electrolytic cells. Computer 36 is typically configured to simply receive and process information received from the coordinators. Any suitable wireless communications network 34 can be employed, including both public and private wireless communications networks 34. For example, IEEE 802.15.4 is commonly used for standard, low-rate, wireless personal area networks. U.S. Ser. Nos. 11/082,545 and 11/082,685 provide a full description of a wireless monitoring system for one or more electrolytic cells.

In a typical ECM system, each cell is monitored by one ECM and in some systems one ECM monitors two or more cells. With respect to cell voltage, one ECM has long been thought sufficient because the copper bus to which the ECM is attached ideally exhibits little, if any, resistance. As such, the voltage as measured on one side of the cell, e.g., the side of the cell at which the electrolyte enters, was expected to be the same as the voltage measured on the opposite side of the cell, e.g., the side of the cell at which the electrolyte exits. If the cell voltage dropped, then an operator knew that the cell had a short. However, while a cell always had a short when this one-sided cell voltage system reported a short; cells for which the system did not report a short were also found to contain shorts.

These missed shorts are detected by a two-sided cell voltage system. In this system, the cell has an ECM attached to each of two cell walls, preferably the electrolyte in-flow wall and the electrolyte out-flow wall. The actual placement of the ECM on each wall or another wall of the cell is not as important as connecting each ECM to the cell bus or rail carrying electricity from the electrolyte in-flow wall to the electrolyte out-flow wall. In this manner, if a difference in cell voltage is detected from one side of the rail to the other, then this difference may be indicative of the existence of a short or bad contact in the cell.

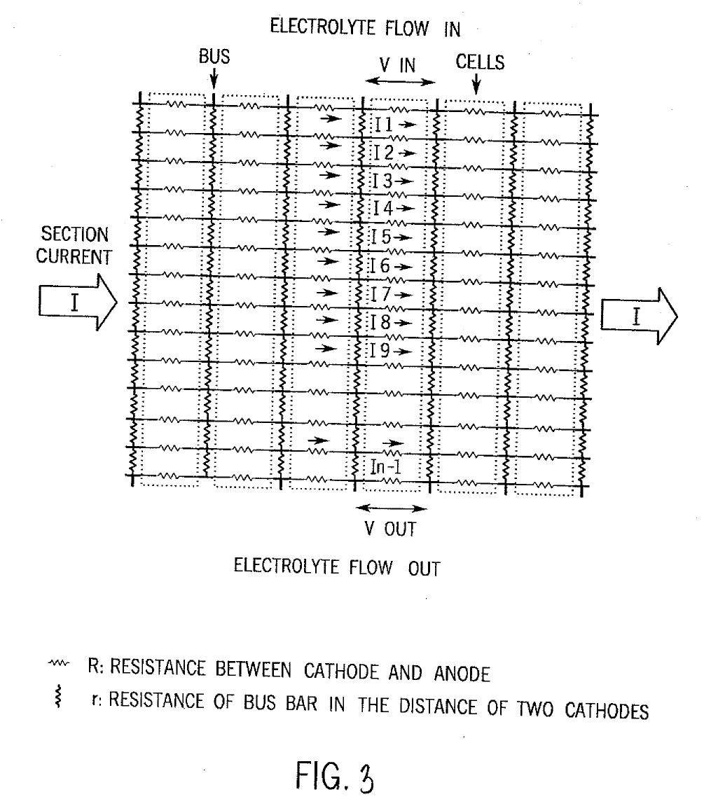

FIG. 3 is a simplified resistance model of electrolytic refining cells connected serially and powered by a current source (e.g., a rectifier). An anode and a cathode form a pair of electrodes and a resistance R exists between the two when they are brought in contact with an electrolyte. R can be estimated under a given consumption (ignoring the resistance of the contacts between the bus and the anode ear, and between the bus and the cathode bar). For a typical cell design, the typical cell voltage is 0.25 volts (V) and the current is 25,000 amperes (A). Thus

$$R = \frac{V}{I} = \frac{0.25}{25000}$$

$$46 = 0.46 m Ω$$

The bus bar is made of copper. Assume the resistance of the bus bar between two cathodes (or two anodes) is r. In an ideal situation, i.e., one without a bad contact, R is uniformly distributed. The circuit shown in FIG. 3 is balanced. The cell voltage measured at A side V1 will be essentially the same as that measured at the B side V2. However, if shorts exist, or if bad contacts exist close to one side of the cell, this will cause unbalance to the circuit and will generate unbalanced vertical current components. Because the current flow in the circuit normally is very large, even very small resistance in the bus will create a considerable voltage drop across the bus. For example, a 500 A vertical flow current will create a 50 mV (millivolt) voltage drop on a 0.1 mΩ (micro-ohm) resistance, which is very significant for cell voltage monitoring system.

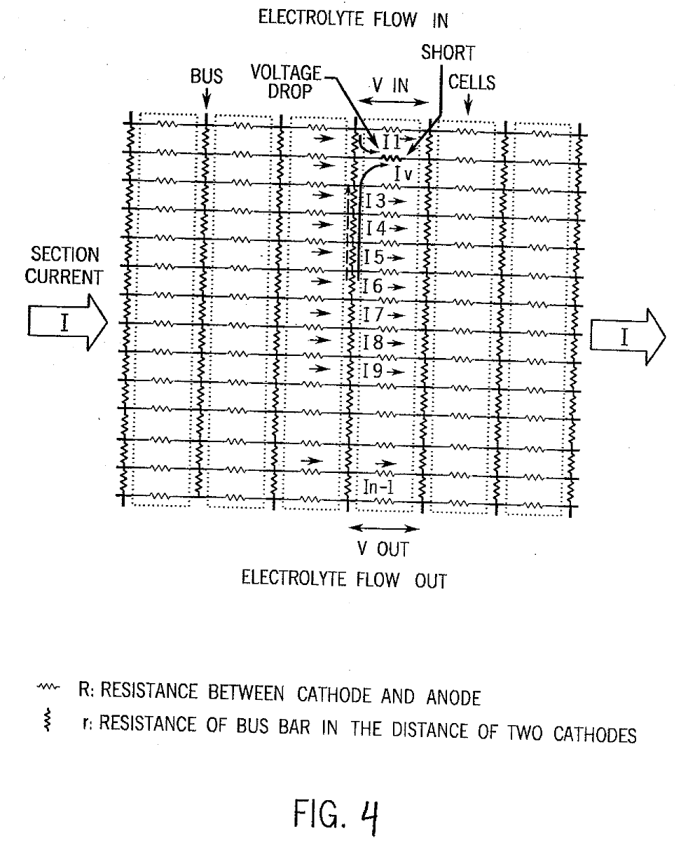

FIG. 4 shows that a short close to the B side creates an unbalanced vertical current in the bus and thus causes a voltage drop along the bus. As such, the voltage monitored at the A side V1 will be higher than the voltage monitored at the B side V2. If a cell monitor is installed only at the A side, the short may not be detected in this case.

The system of this invention will identify the cell or cells with a short or bad contact, but the specific location or locations of shorts within the cell is detected by conventional means, e.g., a gauss meter, an infrared camera or a Hall effect current detector.

### Specific Embodiment

### Test Cell Measurement:

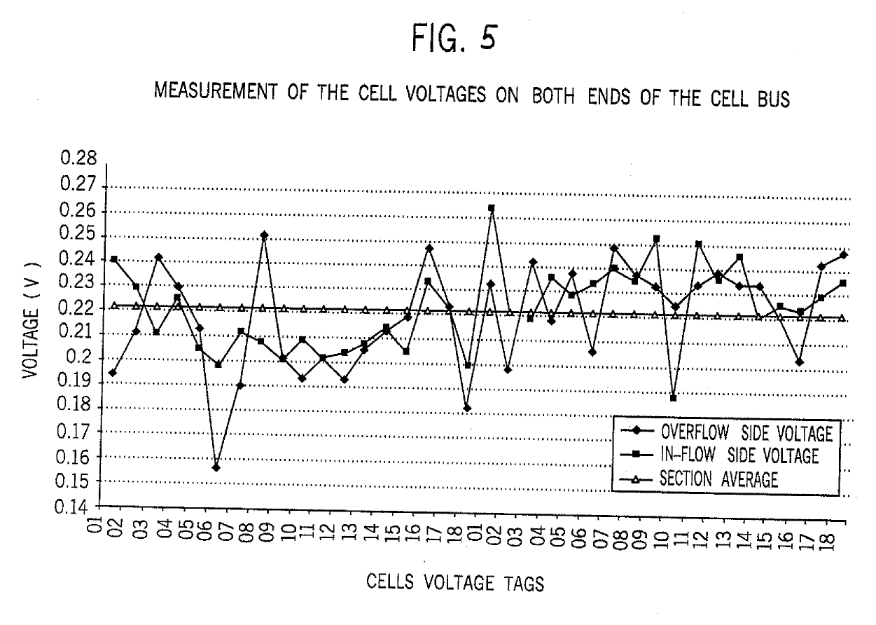

FIG. 5 shows a set of data measured for a group of test cells. The cell voltage on the electrolyte out-flow side of the cell was measured by ECMs installed at the electrolyte out-flow side of the cell. The cell voltage measurement on the electrolyte in-flow side of the cell was measured with a Fluke Multimeter. The data in the graph was collected from the system at the time indicated in the graph starting at 3:55 pm and finishing at 4:01 pm. Because the cell voltages were not changing fast, the data from the ECM on the overflow side was verified with the Fluke to make the comparison. However, the cell voltage on each side of the cell can also be measured by an ECM mounted on each side of the cell or using a Fluke Multimeter on each side of the cell.

As can be seen, for cell 05, the ECM indicates significant shorts in the cell (the cell voltage is much lower than the section average, i.e., the target voltage). However, the voltage taken by the Fluke meter at the other end of the cell shows significant bad contacts (high voltage). Similarly, the ECM shows that cell 08 has bad contacts, but the cell voltage on the other end indicates that shorts exist in the cell. Other examples also show that voltage from one end indicates no shorts, but the voltage from the other end shows the existence of shorts.

Although the invention has been described in considerable detail by the preceding example, this detail is for the purpose of illustration and it is not to be construed as a limitation upon the invention as described in the following claims. All U.S. patents and patent application publications cited in the preceding specification are incorporated herein by reference.

What is claimed is:

1. A method of detecting shorts and bad contacts in an electrolytic cell, the cell comprising a housing, electrolyte and at least one anode/cathode pair, the housing comprising an electrolyte in-flow side and an electrolyte out-flow side and electrical transmission means, the anode/cathode pair, electrolyte and electrical transmission means in electrical communication with one another, the method comprising:
A. Passing an electric current of predetermined amperage through the cell;
B. Measuring the voltage drop across the cell at the electrolyte in-flow side of the housing and at the electrolyte out-flow side of the housing,
C. Comparing the electrolyte in-flow side voltage against the electrolyte out-flow side voltage, and
D. Comparing the electrolyte in-flow and out-flow side voltages against a target voltage.

2. The method of claim 1 in which the cell is an electrolytic cell for the refinement of anode copper to cathode copper.

3. The method of claim 2 in which the electrical transmission means comprises a copper bus.

4. The method of claim 3 in which the voltage is measure at the in-flow and out-flow sides of the bus.

5. A method of detecting a short within an electrolytic cell, the cell comprising:
(i) A housing configured to hold an electrolyte and at least one anode/cathode pair, the housing comprising means for transmitting an electric current and having an electrolyte in-flow side and an electrolyte out-flow side;
(ii) Electrolyte; and
(iii) At least one anode/cathode pair
the means for transmitting an electric current and the anode/cathode pair in electrical communication with one another,
the process comprising:
A. Passing an electric current of pre-determined amperage through the cell;
B. Measuring the voltage drop across the cell at the electrolyte in-flow side of the housing and at the electrolyte out-flow side of the housing,
C. Comparing the electrolyte in-flow side voltage against the electrolyte out-flow side voltage, and
D. Comparing the electrolyte in-flow and out-flow side voltages against a target voltage.

6. The method of claim 5 in which the electrical transmission means is a copper bus.

7. The method of claim 6 in which the housing is a concrete tank, and the anode/cathode pair comprises anode copper and cathode copper.

8. The method of claim 7 in which the electrolyte in-flow and electrolyte out-flow voltage is each measured using an electrolytic cell monitor connected to the copper bus.

9. The method of claim 8 further comprising locating the short within the cell through the use of a gauss meter, Hall effect current detector or an infrared sensor.

10. The method of claim 8 in which the voltage of the electric current in bus at the electrolyte in-flow side of the cell is between about 0.1 and about 1 volt.
